(19) United States
(12) Patent Application Publication
(10) Pub. No.: US 2025/0264872 A1
(43) Pub. Date: Aug. 21, 2025

(54) Method and System for Unsupervised Anomaly Detection

(71) Applicant: ABB Schweiz AG, Baden (CH)

(72) Inventors: Anush Mishra, Indore (IN); Swetha Gunniguntala, Bengaluru (IN); Prabhat Shankar, Bengaluru (IN); Anindya Chatterjee, Bengaluru (IN); Rajesh Ramachandran, Bangalore (IN)

(73) Assignee: ABB Schweiz AG, Baden (CH)

(21) Appl. No.: 18/442,326

(22) Filed: Feb. 15, 2024

(51) Int. Cl. G05B 23/02

(52) U.S. Cl. CPC G05B 23/024; G05B 23/0281

(57) ABSTRACT

Historic operating data for one or more parameters of a machine are obtained. The historic operating data is subsampled to generate a plurality of clusters based on domain knowledge for the machine, each cluster representing data points from the historic operating data that are associated with an operating region for the machine, the domain knowledge includes one or more model parameters associated with the machine. A model file is generated that includes the plurality of clusters of the data points and the one or more model parameters. Test data from the machine is received. A number of nearest neighbors is calculated from the plurality of clusters of the model file to the test data using an algorithm. A distance of the test data from the number of nearest neighbors is calculated. An action is executed based on comparing the distance to a threshold value.

### FIELD

The present disclosure relates to a method and system for identifying anomalies in data sets generated from data provided by machines or systems during operation such as in a facility or industrial application environment.

### BACKGROUND

Maintaining and detecting problems in industrial automation systems or in industrial environments can be a challenging task. Accurately detecting errors in machines operating in such systems typically requires expert or domain knowledge which results in static solutions that fail to account for multiple variables particular to each machine and system. Conventional methods for detecting anomalies fail to account for high dimension data scenarios in data sets generated by systems or machines during operation. To further complicate the issue, the amount of data generated by a machine can be difficult to parse to identify important metrics. Additionally, each machine in an industrial setting may include various operating parameters with different priorities which can truly affect operation of the machine. Without accurate anomaly detection, warning systems may identify false issues resulting in down time of a machine or may miss identifying a problem with a machine which results in a lack of preventive maintenance and the eventual failure of the machine.

### SUMMARY

An embodiment of the present disclosure provides a computer-implemented method for detecting anomalies including obtaining, for a machine over a certain period of time, historic operating data for one or more parameters of the machine, subsampling the historic operating data to generate a plurality of clusters based on domain knowledge for the machine, each cluster representing data points from the historic operating data that are associated with an operating region for the machine, wherein the domain knowledge includes one or more model parameters associated with the machine, generating a model file that includes the plurality of clusters of the data points and the one or more model parameters, receiving test data from the machine, the test data corresponding to current data points for the machine, calculating, to the test data, a number of nearest neighbors from the plurality of clusters of the model file using an algorithm, calculating a distance of the test data from the number of nearest neighbors, and executing an action based on comparing the distance to a threshold value.

In an embodiment, the action includes generating an alarm and transmitting an alarm to a computer device associated with the machine when the distance exceeds the threshold value.

In an embodiment, the action includes transmitting instructions to cease operation of the machine when the distance exceeds the threshold value.

In an embodiment, the action includes suppressing an alarm for transmission to a computer device associated with the machine when the distance does not exceed the threshold value.

In an embodiment, generating the model file includes applying a principal component analysis (PCA) algorithm using the plurality of clusters of the data points to transform the data points to a feature space.

In an embodiment, calculating the distance of the test data from the number of nearest neighbors includes applying the PCA algorithm using the test data to transform the test data to the feature space.

In an embodiment, calculating the distance of the test data from the number of nearest neighbors includes using a Mahalanobis distance.

In an embodiment, the algorithm is a k-nearest neighbors (KNN) algorithm.

In an embodiment, the one or more model parameters include a priority tag, a threshold, an explained variance, and a number of neighbors, wherein the one or more model parameters are generated using the domain knowledge.

In an embodiment, each operating region of the operating regions corresponds to a certain range of values for a parameter of the one or more parameters of the machine, and wherein the certain range of the values is predefined using the domain knowledge.

In an embodiment, the threshold value is based at least in part on at least one of the machine, the operating region, or a priority tag parameter.

Another embodiment of the present disclosure provides a computer system for detecting anomalies, the computer system including one or more hardware processors which, alone or in combination, are configured to provide for execution of the following steps: obtaining, for a machine over a certain period of time, historic operating data for one or more parameters of the machine, subsampling the historic operating data to generate a plurality of clusters based on domain knowledge for the machine, each cluster representing data points from the historic operating data that are associated with an operating region for the machine, wherein the domain knowledge includes one or more model parameters associated with the machine, generating a model file that includes the plurality of clusters of the data points and the one or more model parameters, receiving test data from the machine, the test data corresponding to current data points for the machine, calculating, to the test data, a number of nearest neighbors from the plurality of clusters of the model file using an algorithm, calculating a distance of the test data from the number of nearest neighbors, and executing an action based on comparing the distance to a threshold value.

In an embodiment of the computer system, the action includes generating an alarm and transmitting an alarm to a computer device associated with the machine when the distance exceeds the threshold value.

In an embodiment of the computer system, the action includes transmitting instructions to cease operation of the machine when the distance exceeds the threshold value.

In an embodiment of the computer system, the action includes suppressing an alarm for transmission to a computer device associated with the machine when the distance does not exceed the threshold value.

In an embodiment of the computer system, generating the model file includes applying a principal component analysis (PCA) algorithm using the plurality of clusters of the data points to transform the data points to a feature space.

In an embodiment of the computer system, calculating the distance of the test data from the number of nearest neighbors includes applying the PCA algorithm using the test data to transform the test data to the feature space.

Another embodiment of the present disclosure provides a tangible, non-transitory computer-readable medium having instructions thereon which, upon being executed by one or more processors, provide for detecting anomalies by execution of the following steps: obtaining, for a machine over a certain period of time, historic operating data for one or more parameters of the machine, subsampling the historic operating data to generate a plurality of clusters based on domain knowledge for the machine, each cluster representing data points from the historic operating data that are associated with an operating region for the machine, wherein the domain knowledge includes one or more model parameters associated with the machine, generating a model file that includes the plurality of clusters of the data points and the one or more model parameters, receiving test data from the machine, the test data corresponding to current data points for the machine, calculating, to the test data, a number of nearest neighbors from the plurality of clusters of the model file using an algorithm, calculating a distance of the test data from the number of nearest neighbors, and executing an action based on comparing the distance to a threshold value.

### BRIEF DESCRIPTION OF THE DRAWINGS

The present disclosure will be described in even greater detail below based on the exemplary figures. The disclosure is not limited to the exemplary embodiments. All features described and/or illustrated herein can be used alone or combined in different combinations in embodiments of the disclosure. The features and advantages of various embodiments of the present disclosure will become apparent by reading the following detailed description with reference to the attached drawings which illustrate the following:

FIG. 1 illustrates an example of identifying anomalies using conventional methods;

FIG. 2 illustrates an example of identifying anomalies using the anomaly identification embodiments described herein;

FIG. 3 illustrates a flow chart for identifying anomalies using the anomaly identification embodiments described herein;

FIG. 4 illustrates an example graph to represent a relationship between health scores and Mahalanobis distances between test data and nearest neighbors according to an embodiment of the present disclosure;

FIG. 5 illustrates an example process or method for identifying anomalies using the anomaly identification embodiments described herein;

FIG. 6 illustrates an example user interface for presenting anomalies detected for one or more machines operating in an industrial environment according to an embodiment of the present disclosure;

FIGS. 7A and 7B illustrate a flow chart for identifying anomalies using the anomaly identification embodiments described herein; and

FIG. 8 illustrates a simplified block diagram of one or more devices or systems for identifying anomalies according to embodiments of the present disclosure.

### DETAILED DESCRIPTION

Embodiments of the present disclosure provide a method and system for unsupervised anomaly detection. While the present disclosure is described primarily in connection with machines, systems, or components operated in an industrial setting or environment, such as machines or systems associated with programmable logic controllers (PLCs), as would be recognized by a person of ordinary skill in the art, the disclosure is not so limited and inventive features apply to other components or systems which generate data while in operation.

According to aspects of the present disclosure, a novel unsupervised anomaly detection system is described which provides solutions to problems associated with conventional anomaly detection. For example, the anomaly detection features described herein leverage domain knowledge to subsample data sets to create more useful clusters of data which can be compared to newly received data for a machine to determine if an anomaly exists when comparing distances between the data in a feature space. The anomaly detection features described herein also account for systems which generate multiple variables each with their own priority, and when taken together, can indicate the overall health of a machine or system. Conventional methods utilize entire data sets without subsampling the data using domain knowledge thus making any distance calculations inaccurate.

In an exemplary embodiment, the system enables unsupervised anomaly detection by learning relevant data sets across operating regions for a machine that take into account multiple variables for the machine (e.g., parameters of the machine) by leveraging domain knowledge to subsample the data and cluster the data accordingly. Distances between clustered subsampled data derived from historic operating data and newly arrived data (test data) may be calculated in a feature space using a Mahalanobis distance. Using a Mahalanobis distance increases accuracy and allows for considering the multivariate system being analyzed with one or more parameters. As used herein, test data can refer to real-time or online data generated by a machine or including a data set that represents a simulation of data generated by a machine, component, or system.

As such, the present disclosure enables a highly customizable system that can accurately identify anomalies in data sets while solving problems typically associated with anomaly detection. Not only does this novel mechanism provide practical benefits to operators of facilities which operate machines and systems—such as, reducing unnecessary downtime in operation of the machines by enabling more accurate time points to perform preventative maintenance, but it also provides technical improvements over conventional anomaly detection systems. For example, embodiments of the present disclosure enable more reliable detection of anomalies by leveraging domain knowledge to subsample data, generate more meaningful data clusters, and use Mahalonobis distances between data points in a feature space compared to conventional anomaly detection systems. The features of the present disclosure provide the benefits of early fault detection in machines, better preventative maintenance schedules, improved quality control of machine, increased energy efficiency of machines by updating certain parameters of the machines, process optimization, improved safety by generating warnings or taking other action before catastrophic failure of the machine, continuous monitoring, reduced downtime of the machines, and scalability across facilities.

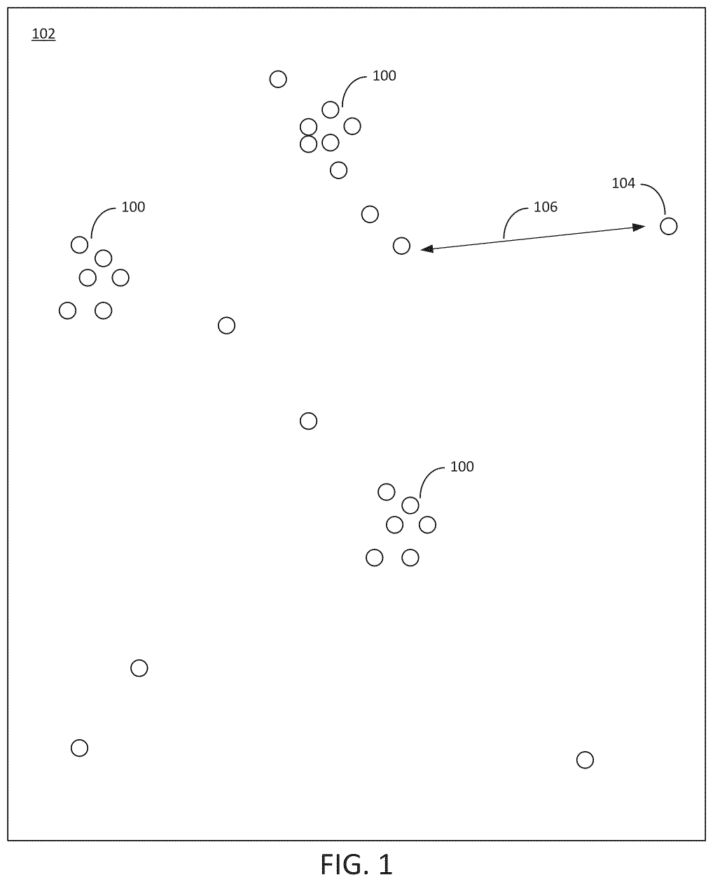

FIG. 1 illustrates an example of identifying anomalies using conventional methods. For example, a machine may provide data during operation which is represented by data points 100 in feature space 102. The data point 104 may represent a new data point for comparison to the data points 100 in order to identify an anomaly using conventional methods. Traditional methods may compare a distance of the new data point 104 to the data points 100 in aggregate to determine a distance (e.g., 106) between the new data point 104 and the data points 100 within the feature space 102. However, by using the entire data set of data points 100, traditional methods end up comparing a new data point 104 with data points 100 from the data set which are not truly representative of relative data points.

By using an entire data set in aggregate to compare to a new data point to detect an anomaly, conventional methods may generate an averaging out result. Generating an averaging out result can produce false positives as well as miss out on true anomalies as they compare entire data sets, such as all data points 100, to a new data point, such as 104, without identifying which portion of the data set is relevant to the new data point 104. Conventional methods may cluster data, but if they do, they cluster the data with respect to all potential variables without consideration of operating ranges or operating regions that are relevant to the new data point 104. By not considering operating ranges or operating regions, conventional methods fail to filter out or remove certain data points 100 from the data set when generating clusters or comparing distances between the new data point 104 and the data points 100 within the feature space 102 thereby decreasing accuracy of anomaly identification. The present disclosure describes anomaly identification embodiments and features which include nearest neighbors as a fine-tunable parameter which can help control the data points included in a cluster which increases the accuracy of determining a distance to the cluster from the set of neighbors.

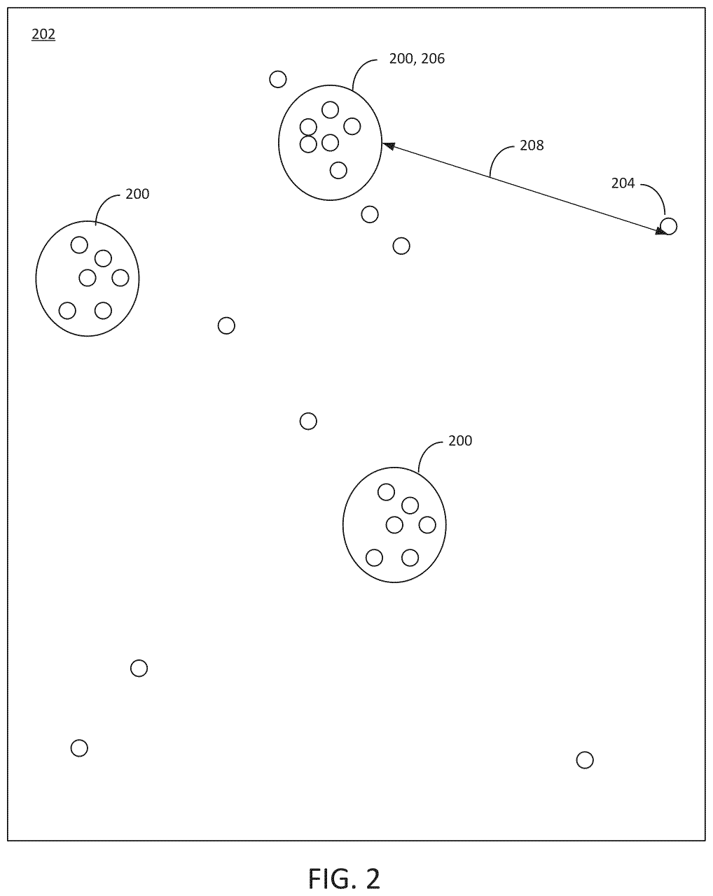

FIG. 2 illustrates an example of identifying anomalies using the anomaly identification embodiments described herein. In comparison to FIG. 1, FIG. 2 includes clusters of data 200 in feature space 202. As described herein, the anomaly identification embodiments and features include filtering historical operating data from a machine and using domain knowledge to define one or more model parameters for clustering the historic operating data into one or more clusters using a hierarchical clustering algorithm or a multivariate clustering algorithm. The clusters of data 200 depicted in FIG. 2 may include historic operating data for one or more parameters of a machine that are transformed via PCA to the feature space 202 for further clustering. FIG. 2 also includes a data point 204 that represents test data for the same machine that was used to generate the data points for clusters 200. In embodiments, the computer system implementing the anomaly identification features and embodiments described herein may obtain the historic operating data from a machine over a certain period of time, e.g., previous number of days, months, year(s), etc., to generate the clusters 200.

The test data 204 may represent a current data point obtained for the same machine. In embodiments, the computer system may be configured to obtain new data (test data) iteratively or periodically over a certain period of time. For example, analysis may be performed using test data collected every 15 minutes once the model file has been generated and implemented by the computer system. Although the above example uses a data collection period of every 15 minutes the embodiments described herein are not limited to such a period of time. For example, test data may be collected every minute, hour, or day or over any periodic time period suitable for the machine or component. In embodiments, the computer system may use a k-nearest neighbors algorithm to identify the closest or nearest cluster 206 to the test data 204. Once the nearest neighbors (e.g., cluster or data point of the cluster) have been identified a distance (Mahalanobis distance) 208 may be determined between the test data 204 and the nearest neighbor 206. The distance 208 may be compared to a threshold distance or value and if it exceeds that threshold or value the test data 204 may be determined to represent an anomaly. In situations where the test data 204 is determined to be an anomaly the system may generate an alarm or warning for the machine or provide instructions for activating or deactivating one or more components of the machine to cease operation of the machine and prevent further damage to the machine.

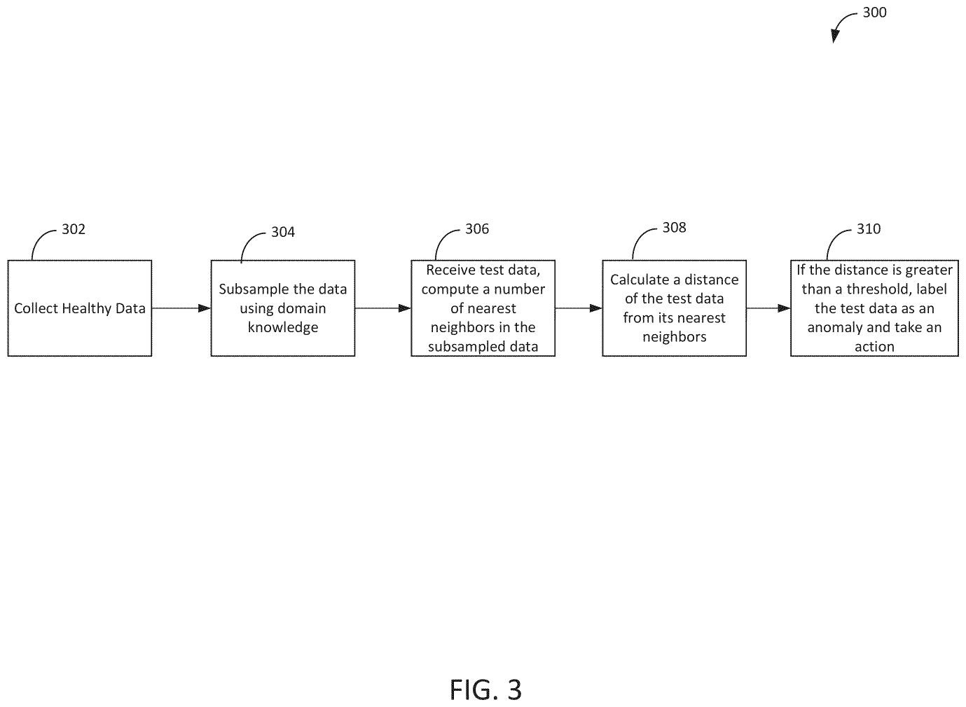

FIG. 3 illustrates a flow chart 300 for identifying anomalies using the anomaly identification embodiments described herein. The flow chart 300 includes collecting healthy data at 302. Collecting healthy data can include obtaining operating data (historic) for a machine over some previous time period or certain period of time. For example, operating data that includes values associated with one or more components or sensors for a machine may be obtained over a previous time period such as previous 3 month period or 8 week period. In embodiments, collecting healthy data may include filtering the obtained historic operating data using one or more noise filtering algorithms or other algorithms for removing junk or garbage data from the data set. The flow chart 300 includes subsampling the data using domain knowledge at 304. In embodiments, the domain knowledge may be used to define or specify a number of model parameters that are used to cluster the data. For example, the domain knowledge may be leveraged to specify a priority tag, a threshold, and an explained variance. In embodiments, each parameter of a machine, such as temperature, speed, pressure, may be associated with a different priority tag that indicates its priority in determining the operating region of the machine. Domain knowledge may be used to determine which parameter of the machine should be given the highest priority, lowest priority and so on. The threshold parameter may be used to obtain data points from the data set that correspond to a certain value that needs to be learned by the model. In a use case about speed, a threshold parameter set to 1 would indicate that each data point change of 1 mile per hour would need to be obtained from the data set, whereas a threshold parameter set to 5 would indicate that each data point change of 5 miles per hour would need to be obtained from the data set.

The explained variance parameter can be used to determine whether to analyze the entire data set using the threshold selected or to exclude a certain percentage of the data set. For example, an explained variance of 100 would indicate that the entire data set is to be analyzed using the threshold parameter. The number of neighbors parameter may be used to specify the number of neighbors which need to be selected for the test point under consideration. In embodiments, these parameters, the clustered data using the parameters, and the transformation of the data points in the cluster using PCA to the feature space are stored in a model file. The parameters of the model may also include a direction of health score value (e.g., higher, lower, normal) that are defined using domain knowledge for each machine parameter that is analyzed. For example, designating temperature with the direction of health score value as higher indicates that the temperature parameter increasing when detecting an anomaly would not result in an indication that the machine has an error or issue.

The process 300 includes at 306 receiving test data and computing a number of nearest neighbors in the subsampled data. In embodiments the test data may correspond to current data points from the machine for parameters of the machine. Determining the number of nearest neighbors may include using a KNN algorithm to determine the number of nearest neighbors from the test data. The process 300 includes at 308 calculating a distance of the test data from its nearest neighbors. The test data may also be transformed using PCA to the same feature space as defined in the model file for determining the distance in the feature space between the test data and the nearest neighbor(s). In embodiments, the distance from the test data to its nearest neighbors includes calculating a Mahalanobis distance between the two data points in the feature space generated via PCA. The process 300 includes at 310 determining if the distance between the test data and the nearest neighbor exceeds a threshold distance or value. In situations where the distance exceeds the threshold distance or value, the test data is determined to represent an anomaly and an action is taken. As described herein, the action can include generating and transmitting alarms or warnings to the machine or a computer device associated with the machine, as well as generating and transmitting instructions to components of the machine to directly interact with said components and cease operation of the components or machine (e.g., activating or deactivating an actuator, cutting or rerouting power, etc.). The threshold distance or value may be defined using domain knowledge and may be machine specific or machine type specific.

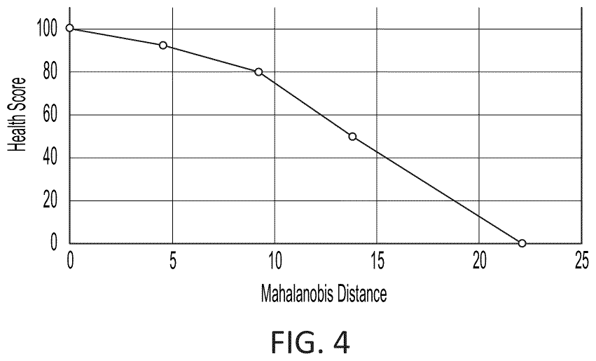

FIG. 4 illustrates an example graph to represent a relationship between health scores and Mahalanobis distances between test data and nearest neighbors according to an embodiment of the present disclosure. As depicted in FIG. 4, the graph illustrates that a smaller Mahalanobis distance between test data and a nearest neighbor(s) cluster or data point from said cluster corresponds to a higher health score. In embodiments, a health score of 100 represents the best health score and corresponds to 0 Mahalanobis distance between the test data and the nearest neighbor. This can represent that the test data does not correspond to an anomaly. As illustrated in FIG. 4, as the distance increases the health score decreases thereby representing a greater likelihood that the test data is an anomaly and that an issue exists with the machine providing the test data. In embodiments, each machine or machine type may be associated with different ranges of health score that correspond to anomaly detection. For example, for one type of machine a health score between 100 and 80 is considered healthy whereas any score below 80 is considered unhealthy and therefore represents an anomaly that corresponds to a problem or issue with the machine. In another type of machine, a health score between 100 and 60 is considered healthy. Domain knowledge or expert knowledge may be used to predefine the health score ranges for each machine or type of machine. It should be noted that the health score and Mahalanobis distance represent a comparison of data points derived from multiple parameters of a machine that are transformed to a feature space via PCA to account for multivariate systems that provide data points for a number of parameters of the machine. The health score provides a more human understandable representation of the overall state of the machine giving priority to certain machine parameters over others based on domain or expert knowledge for the machine.

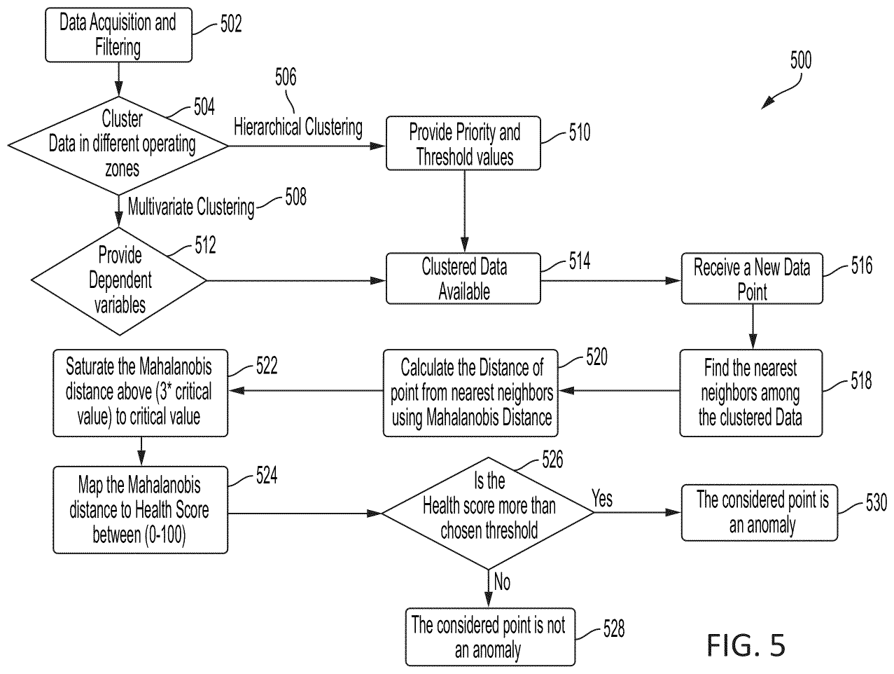

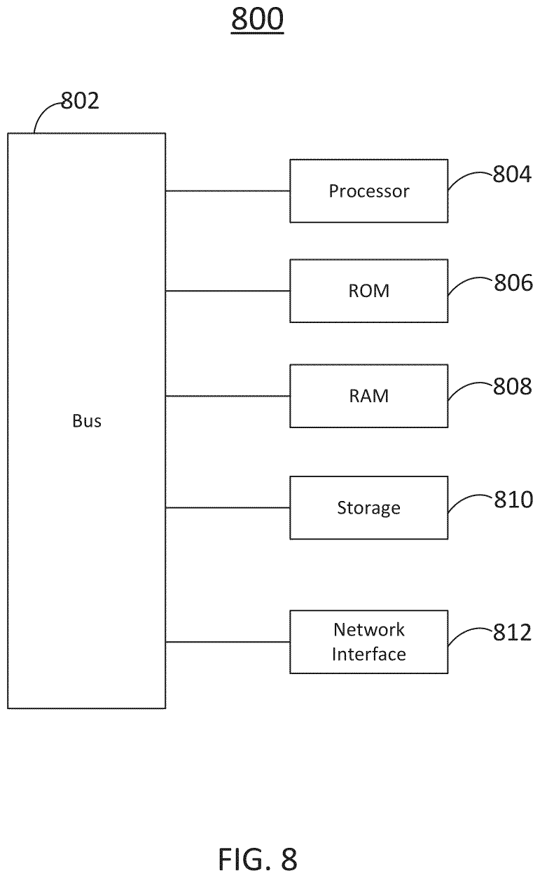

FIG. 5 illustrates an example process or method for identifying anomalies using the anomaly identification embodiments described herein. FIG. 5 includes an exemplary process 500 which may be performed by an environment or architecture such as in FIGS. 3 and 8 and by systems and components of FIGS. 3 and 8. However, it will be recognized that any of the following blocks may be performed in any suitable order and that the process 500 may be performed in any environment or architecture and by any suitable computing device and/or controller.

The process 500 depicts the improved accuracy in identifying anomalies in data sets as described herein by leveraging domain knowledge to remove certain data points from a data set, cluster the remaining data sets which can be used to determine a distance to newly received test data, and determine whether the distance exceeds a threshold distance or value that corresponds to an anomaly. At step 502, the process 500 includes data acquisition and filtering. In embodiments this can include obtaining historic operating data for a machine or system over a certain period of time such as a previous 6 weeks or 6 months. Filtering processes may be applied to remove noise from the data or remove errors in reporting the data by the machine or due to network problems. The process 500 includes at step 504 clustering the data into different operating zones. Operating zones or regions may correspond to particular ranges of values for a given parameter of the machine, e.g., speed, temperature, etc.

In embodiments, the data may be clustered according to a hierarchical clustering method 506 or a multivariate clustering method 508. When utilizing a hierarchical clustering method 506, domain knowledge, either obtained or provided by a user, such as an expert associated with the machine providing the historic operating data, may be used to provide priority and threshold values at step 510 of the process 500. The priority and threshold values may correspond to the domain knowledge and model parameters for forming the clusters using a hierarchical clustering method 506. When utilizing a multivariate clustering method 508, domain knowledge may be used to provide dependent variables at step 512. For example, the domain knowledge may indicate which data points for the parameter of the machine should not be included when clustering the data obtained at step 502 for the machine. The process 500 includes at step 514 having the clustered data available. Having the clustered data available at step 514 can include generating a model file that includes the clustered data and the model parameters used to filter the data. The model file can also include an application of a principal component analysis (PCA) algorithm or process to transform the subsampled data to a feature space.

At step 516, the process 500 includes receiving a new data point (test data) for the machine. In embodiments, the new data point or test data may be transformed using PCA to the same feature space as the model file for the machine. In accordance with at least one embodiment, the anomaly identification features described herein may generate a plurality of model files where each model file corresponds to a different machine or machine type. The process 500 includes at step 518 finding the nearest neighbors among the clustered data to the new data point. In embodiments, finding the nearest neighbors from the clustered data to the new data point can include using a KNN algorithm. The data acquired at 502 that is clustered at 514 and the new data point 516 represent multiple data points for multiple parameters of the machine. Finding the nearest neighbors among the clustered data at 518 includes transforming the new data point received at 516 to the same feature space using PCA.

The process 500 includes at 520 calculating the distance of the new data point from the nearest neighbor(s) in the feature space using a Mahalanobis distance. In embodiments, the distance can be compared to a threshold value or threshold distance to determine if the new data point is an anomaly and therefore indicative of a problem or error with the machine. For example, if the distance is greater than a threshold distance or value, the system may determine that an anomaly exists. If the distance is not greater than the threshold distance or value the system may determine that an anomaly does not exist. In embodiments, the threshold distance or value may be different for each machine or type of machine and set by a user or based on domain or expert knowledge for the machine. At step 522, the process 500 includes saturating the Mahalanobis distance above (3° critical value) to critical value.

In embodiments, using domain knowledge, the system can set a limit to three times a critical value for the distance based on the machine. For example, using domain knowledge, the system may limit the values representing the distance between 0 and 100. If a distance is calculated at 150, it would be converted to 100 as that is the limit. At step 524 of the process 500, the Mahalanobis distance is mapped to a health score between 0 and 100. The mapping to the health score can be aided by the saturation step described for step 522. The process 500 includes at step 526 determining if the health score is more than a chosen threshold. If the health score is not more than the threshold, then the new data point is not considered at anomaly 528, and if the health score is more than the threshold then the new data point is considered an anomaly 530.

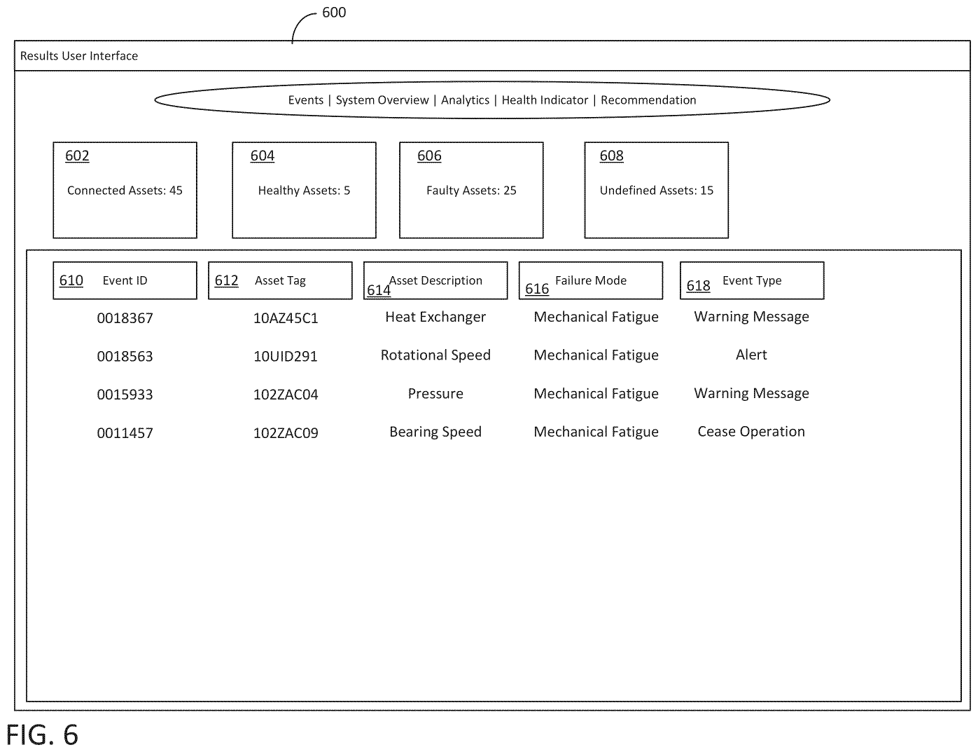

FIG. 6 illustrates an example user interface 600 for presenting anomalies detected for one or more machines operating in an industrial environment according to an embodiment of the present disclosure. In embodiments, the user interface 600 may present results of analyzing test data from one or more machines or systems as described herein. For example, the test data may be compared to data points of clusters that are the nearest neighbor(s) and a distance (Euclidean or Mahalanobis distance) in a feature space to determine if the test data is an anomaly. In embodiments, user interface 600 may present several pieces of data from the analysis of the test data from machines or systems. For example, user interface 600 may present information identifying a number of connected assets 602 that represent the number of components of the machines or systems which have provided test data and are being analyzed. User interface 600 also includes an indicator of a number of healthy assets 604 which represent a number of components whose test data does not exceed a threshold distance (value) when compared to data point(s) of nearest neighbors in a feature space.

User interface 600 includes an indicator of a number of faulty assets 606 which represent a number of components whose test data does exceed a threshold distance (value) when compared to data point(s) of nearest neighbors in a feature space. The fault assets 606 may be associated with test data that have a distance in a feature space that includes clusters of historical operating data that exceeds a threshold distance and is therefore indicative of an anomaly. User interface 600 also includes, in embodiments, an indicator of undefined assets 608. In embodiments, the undefined assets 608 may include assets that have failed to communicate test data to the computer for analysis. This can be due to a communication error or some other problem with a given machine. The user interface 600 may include an area which presents information about the analyzed components (e.g., assets 602) such as an event identifier (ID) 610, an asset tag 612, an asset description 614, a detected failure model 616, and an event type 618.

The event ID 610 may be used to search the interface or information generated by the analysis of a machine or system for particular anomalies detected during analysis using the anomaly detection features described herein. The results of the analysis may be stored by a computer system and/or database and later recalled or searched for further analysis. The asset tag 612 may represent a particular component of a machine or a particular machine. The asset description 614 may be a text description of the particular component that corresponds to the event ID 610 and asset tag 612. The failure mode 616 may identify the particular error or problem associated with the anomaly detection for the asset. In embodiments the event type 618 may correspond to an action executed or performed by the computer analyzing the data to identify anomalies. For example, the computer may generate a warning message and transmit the warning message to a computer device for presentation. In another example, the computer may generate an alert that is provided to a facility, a computer associated with a machine or component, or to the machine or component directly. In embodiments, the computer system may generate instructions for directly interacting with the machine or component being analyzed to prevent further damage such as ceasing operation of the machine or component or cutting off power to the machine or component. The computer system may activate actuators or other components to interface directly with a machine and execute an action to prevent further damage or failure of the machine or component.

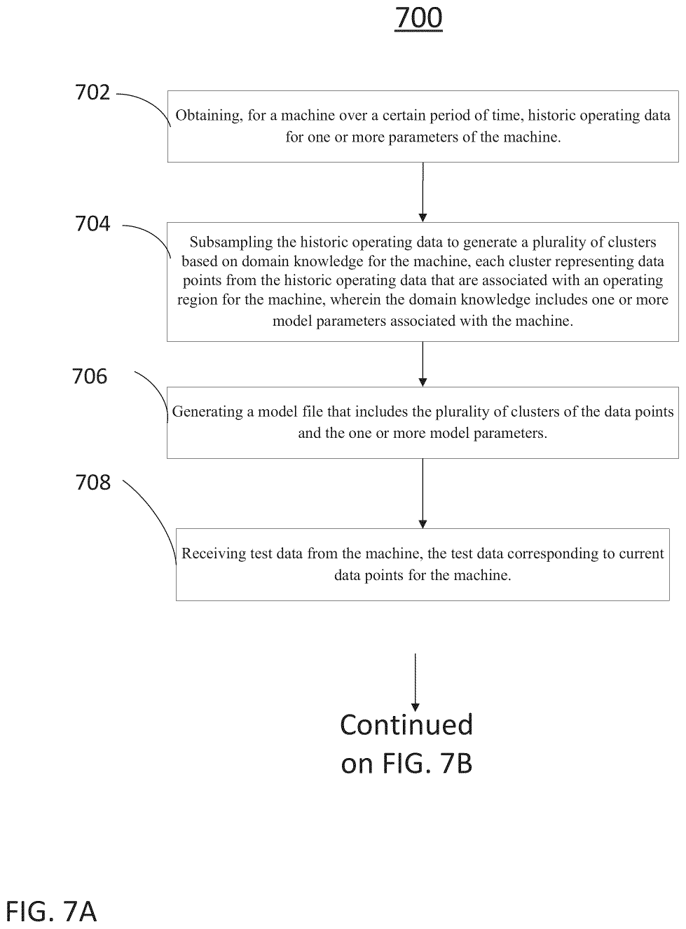

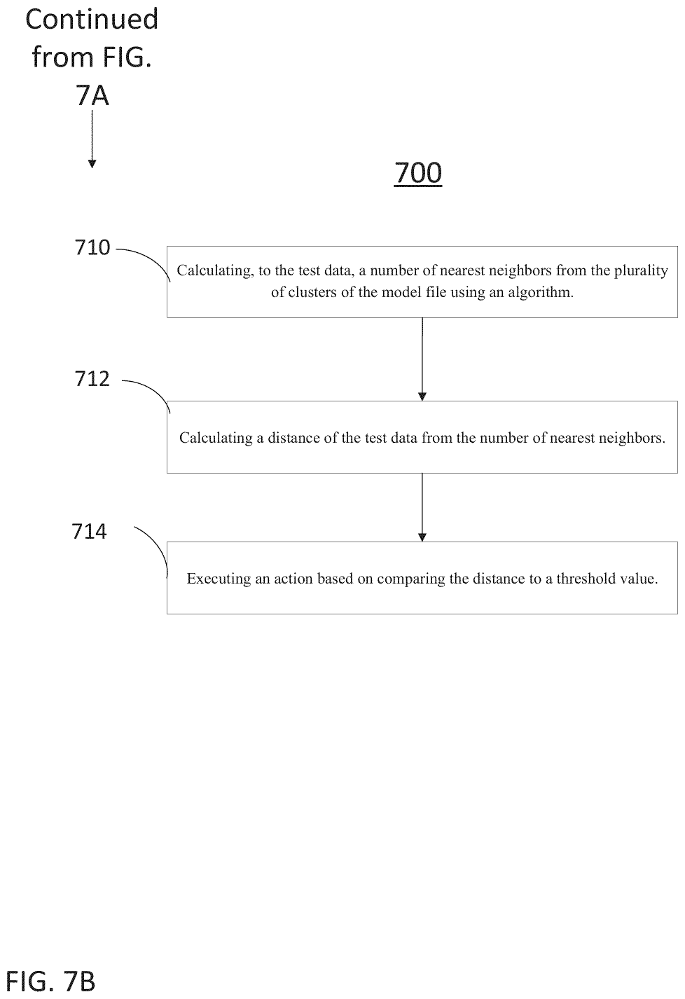

FIGS. 7A and 7B illustrate a flow chart for identifying anomalies using the anomaly identification embodiments described herein. FIGS. 7A and 7B include an exemplary process 700 which may be performed by an environment or architecture such as in FIGS. 3 and 8 and by systems and components of FIGS. 3 and 8. However, it will be recognized that any of the following blocks may be performed in any suitable order and that the process 700 may be performed in any environment or architecture and by any suitable computing device and/or controller.

At step 702, the process 700 includes obtaining, for a machine over a certain period of time, historic operating data for one or more parameters of the machine. For example, operating data (e.g., historic operating data) for a specific machine in an industrial setting or environment may be obtained for a previous 6 month time period. The historic operating data may include values or numbers for the one or more parameters of the machine. For example, the one or more parameters may include operating temperature, bearing ball speed, number of rotations, and pressure of the machine. The process 700 may include, at step 704, subsampling the historic operating data to generate a plurality of clusters based on domain knowledge for the machine, each cluster representing data points from the historic operating data that are associated with an operating region for the machine, wherein the domain knowledge includes one or more model parameters associated with the machine. At step 706, the process 700 may include generating a model file that includes the plurality of clusters of the data points and the one or more model parameters.

The process 700 includes, at step 708, receiving test data from the machine, the test data corresponding to current data points for the machine. At step 710, the process 700 includes calculating, to the test data, a number of nearest neighbors from the plurality of clusters of the model file using an algorithm. The test data corresponds to current data points for the machine as opposed to data points obtained from a previous time period or from historic operations or operating conditions. At step 712, the process 700 includes calculating a distance of the test data from the number of nearest neighbors. The process 700 includes at step 714 executing an action based on comparing the distance to a threshold value. For example, the action could include transmitting instructions to cease operation of the machine, generating and transmitting an alarm to a computer device associated with the machine when the distance exceeds the threshold value, or suppressing an alarm when the distance does not exceed the threshold value. In embodiments, the alarm will not be generated if the distance does not exceed the threshold value.

FIG. 8 illustrates a simplified block diagram of one or more devices or systems for identifying anomalies according to embodiments of the present disclosure. FIG. 8 is a block diagram of an exemplary system or device 800 within an industrial environment, associated with a machine, or otherwise integrated with a machine such as machines for operating automated processes and/or associated with a manufacturing system. The system 800 includes a processor 804, such as a central processing unit (CPU), and/or logic, that executes computer executable instructions for performing the functions, processes, and/or methods described herein. In some examples, the computer executable instructions are locally stored and accessed from a non-transitory computer readable medium, such as storage 810, which may be a hard drive or flash drive. Read Only Memory (ROM) 806 includes computer executable instructions for initializing the processor 804, while the random-access memory (RAM) 808 is the main memory for loading and processing instructions executed by the processor 804.

The network interface 812 may connect to a wired network or cellular network and to a local area network or wide area network. The system 800 may also include a bus 802 that connects the processor 804, ROM 806, RAM 808, storage 810, and/or the network interface 812. The components within the system 800 may use the bus 802 to communicate with each other. The components within the system 800 are merely exemplary and might not be inclusive of every component for embodiments described herein. For instance, in some examples, the system 800 might not include a network interface 812. In embodiments the system 800 may include one or more components for interacting with a machine or system executing an automated process such as actuators, output devices (e.g., speakers or user interfaces), power convertors or power supply systems. The system may use the one or more components for executing an action in response to identifying an anomaly such as ceasing operation of the machine or system, presenting an alarm or warning, visual or auditory, or reducing or otherwise cutting power to a machine to prevent further damage or catastrophic events. In embodiments the network interface 812 may communicate with one or more machines, computers, or systems within a facility or industrial environment to obtain historic operating data, test data, and/or model files for identifying anomalies which may represent issues, problems, or potential failure of a component of a machine or system.

While the disclosure has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present disclosure covers further embodiments with any combination of features from different embodiments described above and below. Additionally, statements made herein characterizing the disclosure refer to an embodiment of the disclosure and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A computer-implemented method for detecting anomalies comprising:
obtaining, for a machine over a certain period of time, historic operating data for one or more parameters of the machine;
subsampling the historic operating data to generate a plurality of clusters based on domain knowledge for the machine, each cluster representing data points from the historic operating data that are associated with an operating region for the machine, wherein the domain knowledge includes one or more model parameters associated with the machine;
generating a model file that includes the plurality of clusters of the data points and the one or more model parameters;
receiving test data from the machine, the test data corresponding to current data points for the machine;
calculating, to the test data, a number of nearest neighbors from the plurality of clusters of the model file using an algorithm;
calculating a distance of the test data from the number of nearest neighbors; and
executing an action based on comparing the distance to a threshold value.

2. The computer-implemented method according to claim 1, wherein the action includes generating an alarm and transmitting an alarm to a computer device associated with the machine when the distance exceeds the threshold value.

3. The computer-implemented method according to claim 1, wherein the action includes transmitting instructions to cease operation of the machine when the distance exceeds the threshold value.

4. The computer-implemented method according to claim 1, wherein the action includes suppressing an alarm for transmission to a computer device associated with the machine when the distance does not exceed the threshold value.

5. The computer-implemented method according to claim 1, wherein generating the model file includes applying a principal component analysis (PCA) algorithm using the plurality of clusters of the data points to transform the data points to a feature space.

6. The computer-implemented method according to claim 5, wherein calculating the distance of the test data from the number of nearest neighbors includes applying the PCA algorithm using the test data to transform the test data to the feature space.

7. The computer-implemented method according to claim 1, wherein calculating the distance of the test data from the number of nearest neighbors includes using a Mahalanobis distance.

8. The computer-implemented method according to claim 1, wherein the algorithm is a k-nearest neighbors (KNN) algorithm.

9. The computer-implemented method according to claim 1, wherein the one or more model parameters include a priority tag, a threshold, an explained variance, and a number of neighbors, wherein the one or more model parameters are generated using the domain knowledge.

10. The computer-implemented method according to claim 1, wherein each operating region of the operating regions corresponds to a certain range of values for a parameter of the one or more parameters of the machine, and wherein the certain range of the values is predefined using the domain knowledge.

11. The computer-implemented method according to claim 1, wherein the threshold value is based at least in part on at least one of the machine, the operating region, or a priority tag parameter.

12. A computer system for detecting anomalies, the computer system comprising one or more hardware processors which, alone or in combination, are configured to provide for execution of the following steps:
obtaining, for a machine over a certain period of time, historic operating data for one or more parameters of the machine;
subsampling the historic operating data to generate a plurality of clusters based on domain knowledge for the machine, each cluster representing data points from the historic operating data that are associated with an operating region for the machine, wherein the domain knowledge includes one or more model parameters associated with the machine;
generating a model file that includes the plurality of clusters of the data points and the one or more model parameters;
receiving test data from the machine, the test data corresponding to current data points for the machine;
calculating, to the test data, a number of nearest neighbors from the plurality of clusters of the model file using an algorithm;
calculating a distance of the test data from the number of nearest neighbors; and
executing an action based on comparing the distance to a threshold value.

13. The computer system of claim 12, wherein the action includes generating an alarm and transmitting an alarm to a computer device associated with the machine when the distance exceeds the threshold value.

14. The computer system of claim 12, wherein the action includes transmitting instructions to cease operation of the machine when the distance exceeds the threshold value.

15. The computer system of claim 12, wherein the action includes suppressing an alarm for transmission to a computer device associated with the machine when the distance does not exceed the threshold value.

16. The computer system of claim 12, wherein generating the model file includes applying a principal component analysis (PCA) algorithm using the plurality of clusters of the data points to transform the data points to a feature space.

17. The computer system of claim 16, wherein calculating the distance of the test data from the number of nearest neighbors includes applying the PCA algorithm using the test data to transform the test data to the feature space.

18. A tangible, non-transitory computer-readable medium having instructions thereon which, upon being executed by one or more processors, provide for detecting anomalies by execution of the following steps:
obtaining, for a machine over a certain period of time, historic operating data for one or more parameters of the machine;
subsampling the historic operating data to generate a plurality of clusters based on domain knowledge for the machine, each cluster representing data points from the historic operating data that are associated with an operating region for the machine, wherein the domain knowledge includes one or more model parameters associated with the machine;
generating a model file that includes the plurality of clusters of the data points and the one or more model parameters;
receiving test data from the machine, the test data corresponding to a current data point for the machine;
calculating, to the test data, a number of nearest neighbors from the plurality of clusters of the model file using an algorithm;
calculating a distance of the test data from the number of nearest neighbors; and
executing an action based on comparing the distance to a threshold value.

19. The tangible, non-transitory computer-readable medium of claim 18, wherein the action includes transmitting instructions to cease operation of the machine when the distance exceeds the threshold value.

20. The tangible, non-transitory computer-readable medium of claim 16, wherein generating the model file includes applying a principal component analysis (PCA) algorithm using the plurality of clusters of the data points to transform the data points to a feature space.
